(19) United States
(12) Patent Application Publication
(10) Pub. No.: US 2006/0147125 A1
(43) Pub. Date: Jul. 6, 2006

(54) Sharpness metric for asymmetrically enhanced image and video

(76) Inventor: Jorge E. Caviedes, Mesa, AZ (US)

Correspondence Address: PHILIPS INTELLECTUAL PROPERTY & STANDARDS, P.O. BOX 3001, BRIARCLIFF MANOR, NY, 10510, US

(21) Appl. No.: 10/561,657

(22) PCT Filed: Jun. 23, 2004
(86) PCT No.: PCT/IB04/50984

§ 371 Date: Dec. 19, 2005

Related U.S. Application Data
(60) Provisional application No. 60/482,950, filed on Jun. 27, 2003.

(51) Int. Cl. G06K 9/40

(52) U.S. Cl. 382/266

(57) ABSTRACT

A sharpness metric represents a control variable of manual (47) or automated (41) sharpness control systems for image and video acquisition, storage and reproduction systems. In manual systems usually one controllable parameter is adjusted seeking to maximize sharpness, within pre-established limits to avoid image distortion. A method for measuring sharpness (10) in an image or picture that may have been enhanced asymmetrically uses statistics from a Discrete Cosine Transformation on predetermined blocks of the image and compensates for asymmetry using information on a number of edge pixels (14) and an energy content of one or more vertical edges and one or more horizontal edges in each block (15). One embodiment for so doing determines a kurtosisbased sharpness metric of the image (12) and then compensates the kurtosis-based sharpness metric to account for differences in sharpness enhancement in a horizontal direction and a vertical direction (13).

The present invention relates generally methods and apparatuses for processing video and image data, and more particularly to a method and apparatus for encoding and decoding video and image data for acquisition, transmission and storage systems.

Measuring sharpness of a video image implies assessing the definition of the edges and the clarity of the details with respect to the background. When an image or video is enhanced asymmetrically, i.e., the amount of horizontal enhancement is different from the vertical enhancement, values given by existing metrics do not correspond to the perceived results in visual tests. For example, some existing techniques compare sharpness of images as long as the relative proportion of horizontal sharpness and vertical sharpness is not modified. When this proportion is changed, the end result is similar to comparing different images, thus making these metrics ineffective in providing consistent results.

A sharpness metric is used in many image capture and display systems to automate sharpness control, enable customizable sharpness settings, and to provide adaptive sharpness enhancement. A sharpness metric can also be used as a control variable for sharpness enhancement algorithms in high-quality digital video, or as a quality indicator for situations in which quality is sufficiently high and other factors remain constant. Combined with other metrics, sharpness can be used to compute overall quality.

Asymmetric sharpness enhancement is an important option used by algorithms that adapt the extent of enhancement to the actual content. Asymmetric sharpness enhancement may arise from the use of a low cost hardware implementation option of 2D sharpness enhancement that uses 1D filters (often found in present day TV sets). The flexibility of the application of 1D filters, and content adaptive enhancement techniques, may result in asymmetric sharpness enhancement. Presently, there is no method for measure sharpness under these conditions.

The present invention is therefore directed to the problem of developing a method and apparatus for quantifying the sharpness of a video image or picture that will operate adequately when an image or picture has been asymmetrically enhanced.

The present invention solves these and other problems by providing a method for measuring asymmetric sharpness enhancement, which uses statistics of a Discrete Cosine Transformation (DCT) taken on eight-by-eight (8×8) blocks (or another convenient size for implementation, in this case 8×8 is compatible with existing implementations of block DCT algorithms) and compensates for asymmetry using information on the number of edge pixels and the energy of vertical and horizontal edges.

According to one aspect of the present invention, a method for measuring sharpness in an image or picture that has been partitioned into one or more blocks employs a kurtosis-based sharpness metric on the image and compensates the kurtosis-based sharpness metric to account for differences in sharpness enhancement in a horizontal direction and a vertical direction.

According to another aspect of the present invention, the compensation includes adding a term to the kurtosis-based sharpness metric based on an average number of edge pixels per block (\overline{nep}), estimated over the entire image or a sample of it.

According to yet another aspect of the present invention, the compensation includes adding a term to the kurtosis-based sharpness metric based on an average horizontal energy (\overline{Eₓ}) and an average vertical energy (\overline{E_{y}}), either estimated over the entire image or from a sample of the image.

According to still another aspect of the present invention, the compensation includes adding a term to the kurtosis-based sharpness metric based on an average horizontal energy (\overline{Eₓ}) and an average vertical energy (\overline{E_{y}}) and an average diagonal energy (\overline{E_{d}}), either estimated over the entire image or from a sample of the image.

According to yet another aspect of the present invention, the compensation includes adding a term to the kurtosis-based sharpness metric based on a number of blocks that contain edges (neb) and a number of blocks that do not contain edges (nfb). In this case, actual values from the entire image or estimates can be used.

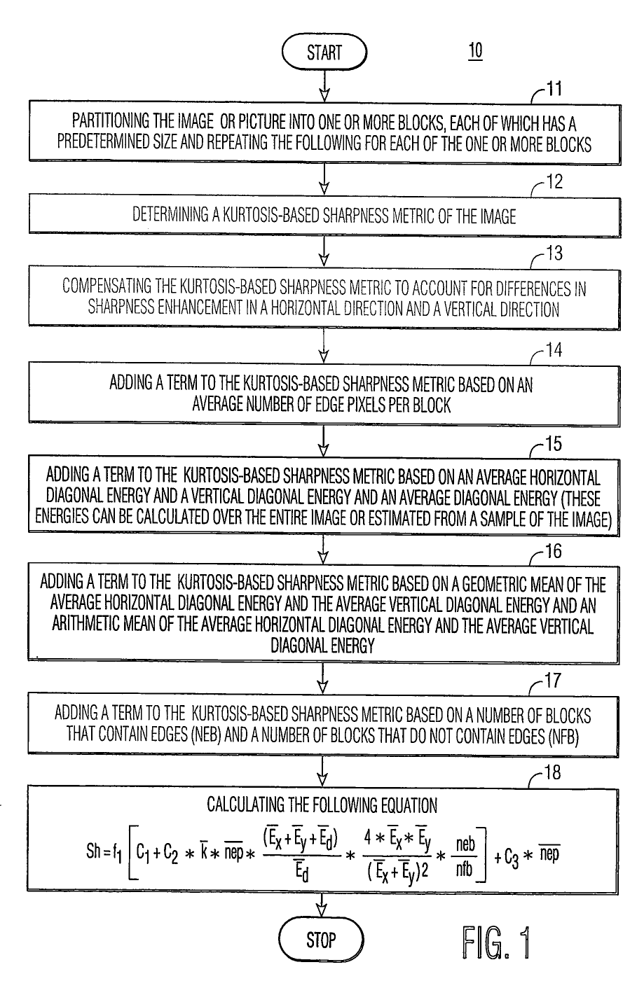

FIG. 1 depicts an exemplary embodiment of a method for measuring sharpness in an asymmetrically enhanced image or picture according to one aspect of the present invention.

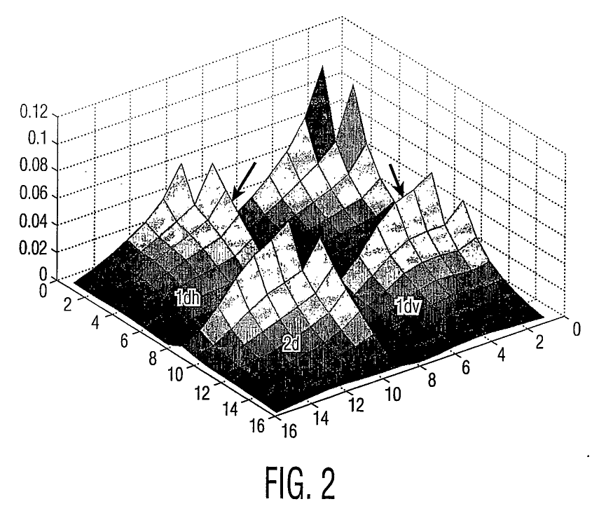

FIG. 2 depicts an exemplary embodiment of a method for computing various energies in an 8×8 Discrete Cosine Transform according to another aspect of the present invention.

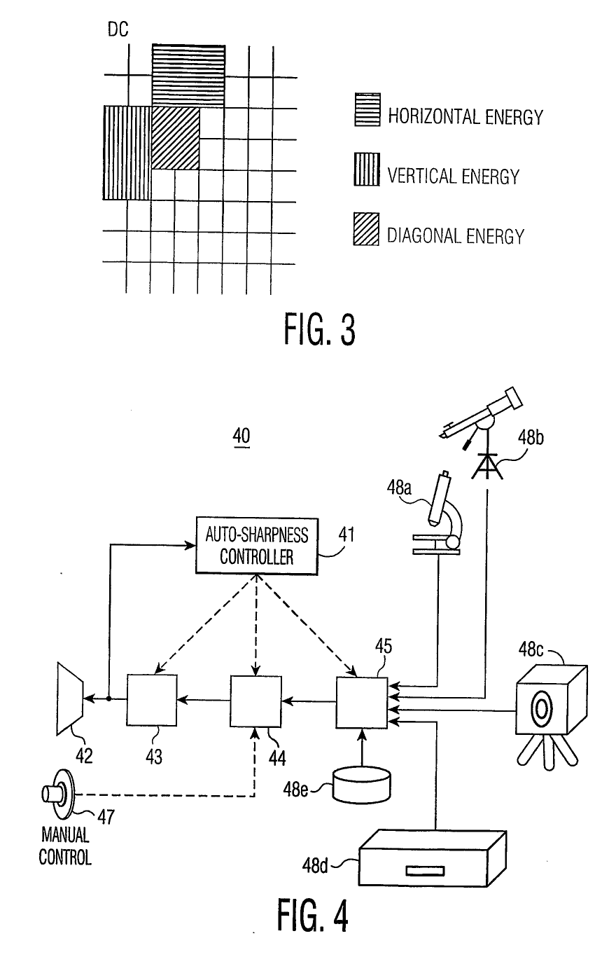

FIG. 3 depicts a plot of an average 8×8 Discrete Cosine Transform for edge blocks showing the effect of sharpness enhancement.

FIG. 4 depicts a generic architecture illustrating different embodiments including manual sharpness control and automated sharpness control for image/video acquisition, storage, and reproduction systems.

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Image post processing and enhancement has become a critical component for digital television systems particularly for high resolution and high definition technologies (comprised image acquisition, storage and reproduction systems). Professional applications such as medical imaging, radar imaging, optical imaging, etc. can also use embodiments of this invention. To assess the effectiveness and control the amount of enhancement, the only solution is to use quality metrics, specifically sharpness metrics. Sharpness is the informal, subjective perception of the clarity of detail and the edges seen in an image. Research on image analysis and perception has shown that sharpness is highly dependent on content, and also on spatial resolution, contrast, and noise.

State of the art enhancement algorithms use asymmetric enhancement in order to increase perceived quality. For example, in many cases enhancing vertical edges has more perceptual impact than enhancing horizontal edges by the same amount. Existing sharpness metrics cannot deal with this case. The present invention allows monitoring and controlling those sharpness enhancement algorithms and other processing that results in asymmetric changes in sharpness.

Embodiments of the present invention may be implemented in sharpness enhancement modules for televisions (e.g., STD, BDTV, LCDTC, PDP, LCOSTV), automatic television control, as well as storage and playback equipment (DVD, DVD-RW, etc.). The sharpness metric is also a component of overall quality metrics for use in the same products and others related to video quality of service. An embodiment of an apparatus for employing the metric calculation of the present invention is shown in FIG. 4.

The 1-dimensional (1D) and 2-dimensional (2D) kurtosis of the frequency spectrum (FFT and DCT) can be useful when determining sharpness metrics. Moreover, sharpness can be measured without the use of a fixed original as reference. The sharpness metric based on the local edge kurtosis has also been incorporated into a no-reference, overall quality metric.

When applying the sharpness metric to the control of sharpness enhancement algorithms, the kurtosis-based metric does not perform well when asymmetric sharpness enhancement, i.e., different horizontal and vertical gain, is used. Unfortunately, asymmetric enhancement is frequently used in order to adapt to content as well as to the sensitivity of the human visual system.

Consensus observations by local researchers, also confirmed by subjective testing, indicate that using a 2d kernel results in sharpness that is larger or comparable to any 1d kernel, and that the relative effect of 1dh and 1dv enhancement depends on content. However, using only the kurtosis metric, in most cases the 2D kernel using equal amounts of vertical and horizontal sharpness ranks near the bottom and occasionally in the middle. The results are similar for interlaced and progressive video.

Therefore, a kurtosis sharpness metric did not accurately reflect the perceived effect of the 2D enhancement in any of the cases tested.

The increase in sharpness measured for increasing gains of the same kernel appears to be well behaved for the kurtosis metric, thus indicating that the metric may not be taking into account some factor that makes the curve for 2D enhancement less steep than the 1D cases. Therefore, other image parameters must be used to compensate for the low sensitivity to 2D enhancement.

Kurtosis is a measure of the “peakedness” of a distribution. A normal distribution has a kurtosis value of three (3), which increases if the peak is higher and the curve narrower. In the case of an 8×8 Discrete Cosine Transformation (DCT), the surface is not normal, or symmetric, but it can be considered as one quadrant of a symmetric surface where peakedness can be partially recognized. Changes in the DCT surface caused by symmetric (2D) sharpness enhancement are reflected by an increase in kurtosis.

FIG. 3 shows the surface plots for the average 8×8 DCT taken over all blocks that contain edges for an original image, a 1DH enhanced version of the same image, a 1DV enhanced version of the same image, and a 2D enhanced version of the same image. The effect of sharpness enhancement produces shifts of the surface towards the higher frequencies, and a swelling effect on the same surface that affects the frequencies affected by the kernel (shown by black arrows in FIG. 3). Those effects push kurtosis values up as if the center of gravity is moving upwards.

For a certain test image, a 1D enhancement in the vertical direction has a much stronger effect on the 2D kurtosis than an enhancement in the horizontal direction. A 1D enhancement in the vertical direction causes a much larger shift of kurtosis than a 2D enhancement that uses the same gain. Notice the more moderate and symmetric effect of the 2D enhancement (2D1 kernel) on the DCT on the surface profile and peaks as compared to the effect of the 1D enhancements in FIG. 3.

The high sensitivity of 2D kurtosis of the DCT to asymmetric processing, suggests that other factors should be taken into account to compensate for asymmetry while preserving the ability to reflect changes in edge sharpness. Two potential compensation factors are considered: edge extent and edge energy in the two directions.

In order to find a more complete model that accounts for sharpness under asymmetric enhancement we use a methodology often used in mathematical modeling, which consists of analyzing the graphs for one variable (or equivalent) at a time and make inferences as to its influence on the model.

We analyze the influence of edge extent by looking at the average number of edge pixels inside 8×8 blocks that contain edges. For the images studied, we notice that the number of edges follows well the observed increase in sharpness. We have determined that 2D enhancement causes the largest increase in average number of edge pixels, especially larger than that of the 1DV enhancement.

Thus, the average number of edge pixels appears to be relevant for the compensation of kurtosis-based sharpness; it reflects perceived differences across enhancement methods. However, edge extent works mainly for enhancement algorithms that use the peaking method; other methods may not cause an increase in the number of edge pixels. We have found that sharpness enhancement resulting from enhanced resolution, used in scalable coders or format conversion, does not cause, and it is not expected to cause an increase in the number of edge pixels. Therefore, another compensation factor is necessary besides the edge extent.

Next, we looked at the amount of vertical and horizontal edge energy contained in the 8×8 DCT for blocks that contain edges. FIG. 2 shows the method used to calculate horizontal, vertical, and diagonal energy of an 8×8 DCT.

Graphing the ratio between average horizontal energy and diagonal energy (Ex/Ey) for a subset of test images shows relative ranking closer to that of the subjective observations for the 1DH, 1DV, and 2D1 enhanced sequences. The results show higher rankings for 2D and 1DV, while the 1DH curve is consistently below the others.

Further analysis of horizontal, vertical and diagonal energy suggests that terms such as the ratio of the geometric mean to the arithmetic mean of horizontal and vertical energy can also be used to compensate for the asymmetry that leads to the exaggerated sharpness values obtained using the kurtosis-based metric.

In principle, modulating the kurtosis by functions of the edge extent and energy can preserve the inter-kernel rankings and shift the curves to capture the correct intra-kernel rankings. The next sections show how this may be accomplished.

In order to propose a function that compensates the kurtosis-based sharpness metric, we have analyzed the behavior of four terms associated with the following global image features:
1. Average number or edge pixels per block (\overline{nep}). As explained before, for methods that increase edge extent, this value gives the expected rankings across kernels.
2. Ratio of the sum of average horizontal, average vertical, and average diagonal energies to the average diagonal energy (i.e.,

$$( i . e . , \frac{{\overline{E}}_{x} + {\overline{E}}_{y} + {\overline{E}}_{d}}{{\overline{E}}_{d}} )$$

for blocks that contain edges. This term is the total energy normalized by the average diagonal energy, which also includes the contribution of textures (textures are not so important as edges to assess sharpness).
3. Ratio of geometric to arithmetic mean of average horizontal and average vertical energies

$$\frac{4 * {\overline{E}}_{x} * {\overline{E}}_{y}}{{( {\overline{E}}_{x} + {\overline{E}}_{y} )}^{2}}$$

raised to the power of 2. This ratio is an eccentricity (Exc) or asymmetry factor, which has a maximum of 1 for symmetric spectra. Its value decreases as the asymmetry goes up.
4. Ratio of the number of blocks that do contain edges to the number of blocks that do not contain edges, or flat blocks, (neb/nfb). This is an important perceptual factor as the perceived sharpness is higher if there are more edge blocks.

We propose a mathematical formula that consists of the combination of the average kurtosis for edge blocks (\overline{ₖ}) and the terms above. Many combinations are possible; we have tested several and came up with a general formulation, which shows the desired modulation of the average kurtosis by the energy and edge extent terms:

$$Sh = {f}_{1} [ {C}_{1} + {C}_{2} * \overline{k} * \overline{nep} * \frac{( {\overline{E}}_{x} + {\overline{E}}_{y} + {\overline{E}}_{d} )}{{\overline{E}}_{d}} * \frac{4 * {\overline{E}}_{x} * {\overline{E}}_{y}}{{( {\overline{E}}_{x} + {\overline{E}}_{y} )}^{2}} * \frac{neb}{nfb} ] + {C}_{3} * \overline{nep} . \qquad ( 1 )$$

f₁ is a logarithmic function ln(x), and constants C₁, C₂, and C₃ are determined experimentally, we use values C₁=1, C₂=0.1, and C₃=0.1, which are believe near the optimum but may be further tuned up based on future experimental data.

Turning to FIG. 1, shown therein is an exemplary embodiment 10 of a method for measuring sharpness in an image or picture. After the image or picture is partitioned into one or more blocks (e.g., 8×8 or some other convenient size (element 11), a kurtosis-based sharpness metric of the image is determined (element 12). This metric is then compensated to account for differences in sharpness enhancement in a horizontal direction and a vertical direction (element 13). One compensation technique compensates by adding a term to the kurtosis-based sharpness metric based on an average number of edge pixels per block (element 14). Compensation can also occur by adding a term to the kurtosis-based sharpness metric based on an average horizontal energy and an average vertical energy and an average diagonal energy (these energies can be calculated over the entire image or estimated from a sample of the image) (element 15). Moreover, a term can be added to the kurtosis-based sharpness metric based on a geometric mean of the average horizontal energy and the average vertical energy and an arithmetic mean of the average horizontal energy and the average vertical energy (element 16). Furthermore, a term can be added to the kurtosis-based sharpness metric based on a number of blocks that contain edges (neb) and a number of blocks that do not contain edges (nfb) (element 17). The above calculations are summarized in the following equation:

$$Sh = {f}_{1} [ {C}_{1} + {C}_{2} * \overline{k} * \overline{nep} * \frac{( {\overline{E}}_{x} + {\overline{E}}_{y} + {\overline{E}}_{d} )}{{\overline{E}}_{d}} * \frac{4 * {\overline{E}}_{x} * {\overline{E}}_{y}}{{( {\overline{E}}_{x} + {\overline{E}}_{y} )}^{2}} * \frac{neb}{nfb} ] + {C}_{3} * \overline{nep} . \qquad ( element 18 )$$

The above sharpness metric, which incorporates edge and energy compensation, has been tested on several images. The results indicate that the 2D kernels exhibit higher sharpness than the 1D kernels. Test results indicate that the 2D kernels are consistently better than the 1D kernels.

Previous results, in which the kurtosis-based sharpness metric showed proper intra-kernel behavior, have been preserved. An interesting case is that of resolution enhanced video, which shows different levels of sharpness corresponding to the levels of perceived quality. The compensated sharpness metric values, plotted frame-by-frame show that sharpness levels correspond with the visual observations, i.e., higher sharpness for higher resolution. Either averaging over a time window or using values per frame, the sharpness metric is effective to detect changes due to enhancement.

Testing indicates that the performance of the prior kurtosis metric has been preserved while improving results for asymmetric sharpness enhancements. Kurtosis of the edge regions is a very promising indicator of sharpness, and if compensated for edge extent and energy asymmetry such kurtosis can also deal with asymmetric sharpness enhancement. The compensation terms used in this work are all global, that is, average values taken over the blocks that contain edges. Local kurtosis can also be compensated to measure sharpness at the local level using a probabilistic approach derived from the global statistics. The terms used so far reflect the global statistical aspects of the image while the specific conditions at the local level can deviate largely from the average, for example the number of edge pixels in a block varies from 1 to 28 or more, and the energy values can also change broadly. Thus, to predict local enhancement we can use models derived from global data.

FIG. 4 depicts a block diagram of a general embodiment 40 showing either a manual sharpness controller 47 or an automatic sharpness controller 41 used in, for example, acquisition, storage and reproduction video/image systems. In an automatic sharpness controller 41, the sharpness metric is computed from the image or part of it, and controllable parameters in the video chain modules 42-45 are acted upon in order to maximize sharpness within allowable range. The image source can be an acquisition module (e.g., CCD in a camcorder 48d, optical imagers 48a-c, or a storage unit 48e, such as a VCR, DVD, CD or HD. To detect if someone is using a system that uses symmetric sharpness control, one can simply input an asymmetrically enhanced image, and it would not enhance it anymore, e.g., the system would treat the image as already at a maximum sharpness, when it has been vertically enhanced. A symmetry compensated system would enhance the image in both directions as much as possible. Test patterns made of horizontal and vertical edges would be very easy to use for this purpose.

Although various embodiments are specifically illustrated and described herein, it will be appreciated that modifications and variations of the invention are covered by the above teachings and are within the purview of the appended claims without departing from the spirit and intended scope of the invention. For example, certain forms of equations are used to model sharpness, however, other functions employing similar compensation terms can be used without departing from the scope of the present invention. Furthermore, this example should not be interpreted to limit the modifications and variations of the invention covered by the claims but is merely illustrative of one possible variation.

1. A method for measuring sharpness in an image or picture comprising: partitioning the image or picture into one or more blocks, each of which has a predetermined size and repeating the following for each of the one or more blocks (11):
determining a kurtosis-based sharpness metric of the image (12); and
compensating the kurtosis-based sharpness metric to account for differences in sharpness enhancement in a horizontal direction and a vertical direction (13).

2. The method according to claim 1, wherein said compensating includes adding a term to the kurtosis-based sharpness metric based on an average number of edge pixels per block (\overline{nep}) (14).

3. The method according to claim 1, wherein said compensating includes adding a term to the kurtosis-based sharpness metric based on an average horizontal energy (\overline{Eₓ}) and an average vertical energy (\overline{E_{y}}) (15).

4. The method according to claim 1, wherein said compensating includes adding a term to the kurtosis-based sharpness metric based on an average horizontal energy (\overline{Eₓ}) and an average vertical energy (\overline{E_{y}}) and an average diagonal energy (\overline{E_{d}}) (15).

5. The method according to claim 1, wherein said compensating includes adding a term to the kurtosis-based sharpness metric based on a geometric mean (Eₓ*E_{y})^{1/2} of the average horizontal energy (\overline{Eₓ}) and the average vertical energy (\overline{E_{y}}) (16).

6. The method according to claim 1, wherein said compensating includes adding a term to the kurtosis-based sharpness metric based on an arithmetic mean [½(\overline{Eₓ}+\overline{E_{y}})] of the average horizontal energy (\overline{Eₓ}) and the average vertical energy (\overline{E_{y}}) (16).

7. The method according to claim 1, wherein said compensating includes adding a term to the kurtosis-based sharpness metric based on a geometric mean (Eₓ*E_{y})^{1/2} of the average horizontal energy (\overline{Eₓ}) and the average vertical energy (\overline{E_{y}}) and an arithmetic mean [½(\overline{Eₓ}+\overline{E_{y}})] of the average horizontal energy (\overline{Eₓ}) and the average vertical energy (\overline{E_{y}}) (16).

8. The method according to claim 1, wherein said compensating includes adding a term to the kurtosis-based sharpness metric based on a number of blocks that contain edges (neb) (17).

9. The method according to claim 1, wherein said compensating includes adding a term to the kurtosis-based sharpness metric based on a number of blocks that do not contain edges (nfb) (17).

10. The method according to claim 1, wherein said compensating includes adding a term to the kurtosis-based sharpness metric based on a number of blocks that contain edges (neb) and a number of blocks that do not contain edges (nfb) (17).

11. The method according to claim 4, wherein said compensating includes adding a term to the kurtosis-based sharpness metric based on an average number of edge pixels per block (\overline{nep}) (14).

12. The method according to claim 7, wherein said compensating includes adding a term to the kurtosis-based sharpness metric based on an average number of edge pixels per block (\overline{nep}) (14).

13. The method according to claim 10, wherein said compensating includes adding a term to the kurtosis-based sharpness metric based on an average number of edge pixels per block (\overline{nep}) (14).

14. The method according to claim 12, wherein said compensating includes adding a term to the kurtosis-based sharpness metric based on an average horizontal energy (\overline{Eₓ}) and an average vertical energy (\overline{E_{y}}) and an average diagonal energy (\overline{E_{d}}) (15).

15. The method according to claim 11, wherein said compensating includes adding a term to the kurtosis-based sharpness metric based on a number of blocks that contain edges (neb) and a number of blocks that do not contain edges (nfb) (17).

16. The method according to claim 4, wherein said compensating includes adding a term to the kurtosis-based sharpness metric based on a geometric mean (Eₓ*E_{y})^{1/2} of the average horizontal energy (\overline{Eₓ}) and the average vertical energy (\overline{E_{y}}) and an arithmetic mean [½(\overline{Eₓ}+\overline{E_{y}})] of the average horizontal energy (\overline{Eₓ}) and the average vertical energy (\overline{E_{y}}). The ratio of the geometric to arithmetic mean raised to the power of 2,
$$\frac{4 * {\overline{E}}_{x} * {\overline{E}}_{y}}{{( {\overline{E}}_{x} + {\overline{E}}_{y} )}^{2}} ,$$
is the combined compensation term (16).

17. The method according to claim 16, wherein said compensating includes adding a term to the kurtosis-based sharpness metric based on a number of blocks that contain edges (neb) and a number of blocks that do not contain edges (nfb) (17).

18. The method according to claim 13, wherein said compensating includes adding a term to the kurtosis-based sharpness metric based on a geometric mean (Eₓ*E_{y})^{1/2} of the average horizontal energy (\overline{Eₓ}) and the average vertical energy (\overline{E_{y}}) and an arithmetic mean [½(\overline{Eₓ}+\overline{E_{y}})] of the average horizontal energy (\overline{Eₓ}) and the average vertical energy (\overline{E_{y}}) (16).

19. The method according to claim 4, wherein said compensating includes adding a term to the kurtosis-based sharpness metric based on a number of blocks that contain edges (neb) and a number of blocks that do not contain edges (nfb) (17).

20. The method according to claim 7, wherein said compensating includes adding a term to the kurtosis-based sharpness metric based on a number of blocks that contain edges (neb) and a number of blocks that do not contain edges (nfb) (17).

21. The method according to claim 14, wherein said compensating includes adding a term to the kurtosis-based sharpness metric based on a number of blocks that contain edges (neb) and a number of blocks that do not contain edges (nfb) (17).

22. The method according to claim 1, wherein the compensating includes calculating the following equation:
$$Sh = {f}_{1} [ {C}_{1} + {C}_{2} * \overline{k} * \overline{nep} * \frac{( {\overline{E}}_{x} + {\overline{E}}_{y} + {\overline{E}}_{d} )}{{\overline{E}}_{d}} * \frac{4 * {\overline{E}}_{x} * {\overline{E}}_{y}}{{( {\overline{E}}_{x} + {\overline{E}}_{y} )}^{2}} * \frac{neb}{nfb} ] + {C}_{3} * \overline{nep} ,$$
wherein:
Sh is a sharpness metric;
f₁ is a predetermined function;
C₁, C₂ and C₃ are predetermined constants;
\overline{k} is an average kurtosis;
\overline{nep} is an average number of edge pixels per block;
\overline{E_{y}} is an average vertical energy;
\overline{Eₓ} is an average horizontal energy;
\overline{E_{d}} is an average diagonal energy;
neb is a number of blocks that contain edges; and
nfb is a number of blocks that do not contain edges (18).

23. The method according to claim 7, wherein the average vertical and horizontal energies are obtained by calculating values over the entire image (15).

24. The method according to claim 7, wherein the average vertical and horizontal energies are estimated from a sample of the image (15).

25. A method for measuring sharpness in an image or picture comprising:
performing a Discrete Cosine Transformation on each of a plurality of blocks of a predetermined size of the image; and
compensating for asymmetry using information on a number of edge pixels and an energy content of one or more vertical edges and one or more horizontal edges in each of the plurality of blocks (13).

26. An image processing apparatus (40) comprising:
an image detector (48a-e) to convert the image to an electronic version; and
a sharpness controller (41) coupled to the image detector to detect sharpness in the electronic version of the image and adjust the sharpness, said controller to calculate a sharpness metric of the image by:
partitioning the image or picture into one or more blocks, each of which has a predetermined size and repeating the following for each of the one or more blocks (11):
determining a kurtosis-based sharpness metric of the image (12); and
compensating the kurtosis-based sharpness metric to account for differences in sharpness enhancement in a horizontal direction and a vertical direction (13).

27. The apparatus according to claim 25, wherein said compensating includes adding a term to the kurtosis-based sharpness metric based on an average number of edge pixels per block (\overline{nep}) (14).

28. The apparatus according to claim 25, wherein said compensating includes adding a term to the kurtosis-based sharpness metric based on an average horizontal energy (\overline{Eₓ}) and an average vertical energy (\overline{E_{y}}) and an average diagonal energy (\overline{E_{d}}) (15).

29. The apparatus according to claim 25, wherein said compensating includes adding a term to the kurtosis-based sharpness metric based on a geometric mean (Eₓ*E_{y})^{1/2} of the average horizontal energy (\overline{Eₓ}) and the average vertical energy (\overline{E_{y}}) and an arithmetic mean [½(\overline{Eₓ}+\overline{E_{y}})] of the average horizontal energy (\overline{Eₓ}) and the average vertical energy (\overline{E_{y}}) (16).

30. The apparatus according to claim 25, wherein said compensating includes adding a term to the kurtosis-based sharpness metric based on a number of blocks that contain edges (neb) and a number of blocks that do not contain edges (nfb) (17).

31. The apparatus according to claim 28, wherein the average vertical and horizontal energies are obtained by calculating values over the entire image (16).

32. The apparatus according to claim 28, wherein the average vertical and horizontal energies are estimated from a sample of the image (16).
